(19) United States
(12) Patent Application Publication
(10) Pub. No.: US 2006/0082516 A1
(43) Pub. Date: Apr. 20, 2006

(54) Dielectric-resonator array antenna system

(76) Inventor: Peter C. Strickland, Ottawa (CA)

Correspondence Address: Edward F. Behm, Jr.;2500 One Liberty Place, 1650 Market Street, Philadelphia, PA, 19103, US

(21) Appl. No.: 11/142,101

(22) Filed: Jun. 1, 2005

Related U.S. Application Data
(63) Continuation-in-part of application No. 10/858,262, filed on Jun. 1, 2004.

(51) Int. Cl. H01Q 9/04

(52) U.S. Cl. 343/872; 343/700 MS

(57) ABSTRACT

A dielectric resonator element array (DRA) antenna system and method for using same is disclosed. The dielectric resonator antenna system includes a ground plain, a feed structure, an array of dielectric resonator elements electrically coupled to the feed structure, each dielectric element having a relatively high permittivity, a radome close to or in contact with the array of dielectric resonator elements, an object mounting apparatus for mounting the antenna system on an object, and a beam shaping and steering controller, the beam shaping and steering controller controlling the feed structure to thereby control excitation phases of the dielectric resonator elements.

### CROSS-REFERENCE TO RELATED APPLICATIONS

This application claims priority to U.S. patent application Ser. No. 10/858,262, entitled “Dielectric-Resonator Array Antenna System” filed Jun. 1, 2004, which application is hereby incorporated by reference herein as if set forth in the entirety.

### FIELD OF THE INVENTION

This invention relates generally to antennae, and, more particularly, to dielectric-resonator array antennae system and method.

### BACKGROUND OF THE INVENTION

Aeronautical antenna systems for satellite communications can be very large in area, which results in increased air drag and more weight for the aircraft on which the antenna system is mounted. Increased drag and weight result in a reduction in the aircraft's flying range, increased fuel consumption and corresponding higher aircraft operational costs. Large antenna systems can also increase lightning and bird strike risks, as well as degrade the visual aesthetics of the aircraft.

Communications with satellites using physically small antenna arrays requires an exceptionally low noise temperature and high aperture efficiency. In aeronautical applications, the antenna should also be narrow and have a low profile in order to minimize drag and not deviate excessively from the contours of the aircraft. Conventional antenna systems for aeronautical satellite communications (SATCOM) applications, in the lower microwave frequency bands, typically utilize either drooping-crossed-dipole elements or microstrip patch radiators. The crossed-dipole element is relatively tall, resulting in high drag, and the microstrip patch element has both narrow beamwidth and narrow bandwidth, which restrict the antenna's performance. The narrow beamwidth of the patch element results in excessive gain loss and impedance mismatch when the array beam peak is scanned toward the aircraft horizon with the antenna mounted on the top of the fuselage. The narrow bandwidth of the patch radiator makes the impedance mismatch more catastrophic at extreme scan angles. These effects reduce the gain of the antenna system, thus demanding a larger antenna footprint and overall larger antenna size.

Conventional antenna systems also use simple look-up tables for determining element phase settings for a given beam position relative to the airframe. This approach does not minimize interference with other satellites on the geosynchronous arc and consequently the size of the conventional antenna must be relatively large in order to achieve a desired degree of isolation against adjacent satellites. Consequently, the size of the antenna must be relatively large in order to achieve a desired degree of isolation against satellites other than the one with which communication is desired.

Some existing high gain phased array antenna systems for aeronautical Inmarsat applications include the CMA-2102 antenna system by CMC Electronics, the T4000 antenna system by Tecom, the HGA 7000 antenna system by Omnipless, and the Airlink and Dassault Electronique Conformal antenna system by Ball Aerospace. The CMA-2102 and Tecom T4000 antenna systems are conventional drooping crossed dipole arrays of large size that use conventional steering algorithms and conventional mounting techniques. The Omnipless HGA 7000 antenna system has not yet been sold commercially and is of unknown construction. The Ball Aerospace Airlink and Dassault Electronique conformal antenna systems are conventional microstrip patch arrays that use conventional steering algorithms and conventional mounting techniques.

Further, the mounting of a phase-scanned array to an aircraft can be problematic if the goal is to minimize size and drag. In particular, the mounting hardware must not increase the size of the array (in order to avoid further drag and avoid degradation of the aesthetic appearance of the antenna) and must not degrade the radiation pattern of the antenna significantly. The mounting hardware of known antennas is predominantly outside of the perimeter of the radiating structure. Consequently, the overall size of the array in such systems is increased through the addition of the mounting hardware. In particular, prior art systems typically use a flange about the perimeter of the array through which machine screws can be passed. Often, but not always, the radome in prior art systems has a similar flange and mounting hardware passing through the radome and array base.

Therefore, the need exists for a small antenna system that can be mounted on a small surface area, and which has high gain in directions of intended communication and low interference. A need also exists for a small, compact antenna system that has high beam-steering accuracy, wide bandwidth and very efficient radiation.

While the present invention is described herein below, for illustrative purposes, as being applied to certain specific dielectric-resonating antennas, such as dielectric-resonator array antennae, it will be understood that the present invention can be employed in any antenna system that can utilize a compact antenna system that has high beam-steering accuracy, wide bandwidth and very efficient radiation.

### SUMMARY OF THE INVENTION

The present invention is directed to an aeronautical antenna system which includes an array of dielectric resonators, a beam steering controller, a diplexer assembly, a radome; and a mechanism for attaching dielectric resonator array to outside of airframe.

The present invention also includes an array of dielectric resonators which incorporates two or more dielectric resonators, has a microwave feed combining or dividing the power amongst the various resonators and a means is provided for independently controlling the relative excitation and/or reception phase of one or more of the dielectric resonators.

The present invention also includes dielectric resonators composed of low conductivity, high permittivity, material having a low loss tangent and are designed to resonate, and radiate and/or receive, at the desired antenna system operational frequencies. Further, some conductive material may be embedded in the dielectric resonator and/or be on the outside surface to alter the radiation, impedance or mechanical properties of the dielectric resonator.

The present invention also includes a beam steering controller that controls the excitation and/or reception phases associated with one or more of the dielectric resonators in order to direct the antenna's beam or beams to desired satellites and/or to control the shape of the antenna beam or beams.

The present invention further includes a diplexer assembly providing isolation between the transmit and receive operating frequencies such that the system has separate transmission and reception ports.

It is to be understood that the figures and descriptions of the present invention have been simplified to illustrate elements that are relevant for a clear understanding of the present invention, while eliminiating, for the purposes of clarity, many other elements found in a typical inventory tracking system. Those of ordinary skill in the pertinent art will recognize that other elements are desirable and/or required in order to implement the present invention.

### BRIEF DESCRIPTION OF THE FIGURES

Understanding of the present invention will be facilitated by consideration of the following detailed description of the present invention taken in conjunction with the accompanying drawings, in which like numerals refer to like parts, and wherein:

FIG. 1 is a schematic layout of a known antenna system;

FIG. 2 is a schematic view of an embodiment of the phase shifting and tuning mechanism in a first position and a second position;

FIG. 3 is a schematic diagram of the phase shifting and tuning mechanism according to an aspect of the present invention in a first position and a second position;

FIG. 4 is a schematic view of a phase shifting and tuning mechanism according to an aspect of the present invention;

FIG. 5 is a schematic view of a phase shifting and tuning mechanism according to an aspect of the present invention;

FIG. 6 is a schematic of a side view of the phase shifting and tuning mechanism of FIG. 5 along line 14-14;

FIG. 7 is a schematic of a side view of the phase shifting and tuning mechanism according to an aspect of the present invention;

FIG. 8 is a schematic side view of the phase shifting and tuning mechanism according to an aspect of the present invention;

FIG. 9 is a block diagram of a method for operating the antenna system according to an aspect of the present invention;

FIG. 10 is a block diagram of a method for operating the antenna system according to an aspect of the present invention; and,

FIG. 11 is a block diagram of a method for operating the antenna system according to an aspect of the present invention.

Although the drawings represent embodiments of the present invention, the drawings are not necessarily to scale and certain features may be exaggerated in order to better illustrate and explain the present invention.

### DETAILED DESCRIPTION OF THE INVENTION

It is to be understood that the figures and descriptions of the present invention have been simplified to illustrate elements that are relevant for a clear understanding of the present invention, while eliminating, for the purpose of clarity, many other elements found in typical antenna applications, and systems and methods of using the same. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

The dielectric resonator element array (DRA) antenna system of the invention is well suited for use in a wide range of applications, particularly for data, voice and video satellite communications, and more particularly, for communication with satellites having specific system requirements such as the Inmarsat Aero-H, high gain, or the requirements of the Inmarsat Aeronautical System Definition Manual. However, the antenna system of the present invention is not limited to any particular uses or technological environments. Communications between aircraft and terrestrial, aeronautical, tethered or other platforms are also envisaged, as are non-aeronautical uses such as communications from trucks, busses, trains or ships to terrestrial, aeronautical or satellite platforms. By way of non-limiting example only, the present invention allows the size of the antenna hardware outside an aircraft to be minimized while satisfying regulatory and link requirements such as: interference with other satellites, terrestrial receivers or airborne terminals; required system G/T; and transmit EIRP.

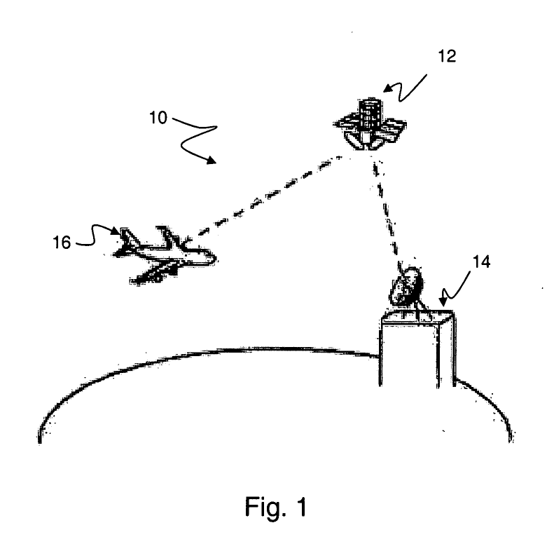

FIG. 1 is an illustration of a DRA antenna system of the present invention as employed in an aeronautical environment 10. A satellite 12 provides a communication link between a terrestrial transceiver 14 and an airplane 16 on which the DRA antenna system is attached. It should be noted that the DRA antenna system of the invention may also be employed on the satellite 12 and that the DRA antenna system may be communicating with fixed or mobile terrestrial transmitters receivers as opposed to, or in addition to, communicating with satellites.

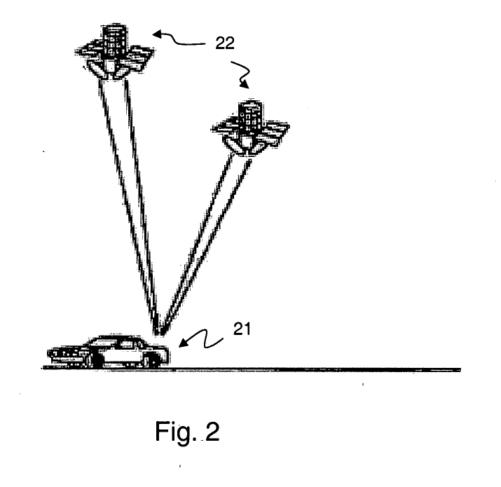

In an embodiment of the present invention, the DRA antenna system may communicate with multiple satellites and/or not with a terrestrial receiver. As illustrated in FIG. 2, an automobile 21 may utilize the present invention to communicate with multiple satellites 22, for example.

The DRA antenna system of the present invention may include a dielectric-resonator array, a radome, a mounting mechanism, a beam steering unit and a diplexer assembly. The use of dielectric resonator radiating elements results in a radically reduced antenna height for a given array coverage. These dielectric resonator elements are of a particular resonator dielectric formulation that also results in low antenna system weight. In addition, the dielectric resonators are designed to operate in close proximity, or in direct contact, with a radome. The radome, which may provide environmental protection, may alter the resonances and patterns of the radiators thus requiring the radiator dimensions to be altered in the presence of the radome structure.

The compact nature of the DRA antenna system of the invention is achievable due to a variety of features, including: low-profile dielectric resonator radiating elements; a pattern synthesis implementation; a compact mounting device that does not add to the array size and helps to minimize edge diffraction effects; a radome that is close to, or in direct contact with, the radiating elements; and an optimal array grid.

These features of the invention may allow the DRA antenna system to have a reduced height and width relative to known systems, which results in reduced aeronautical drag, the ability to install the antenna system in a very small area without excessive gap under the array element plane, and improved beam control.

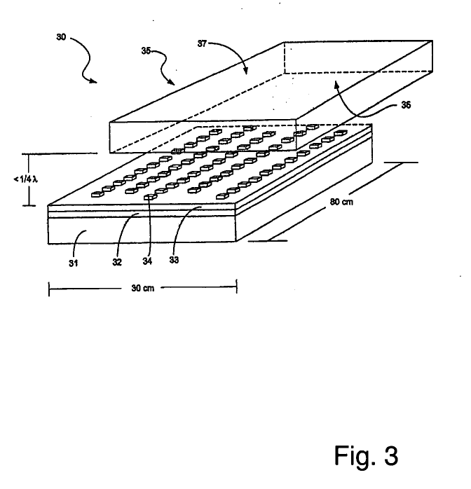

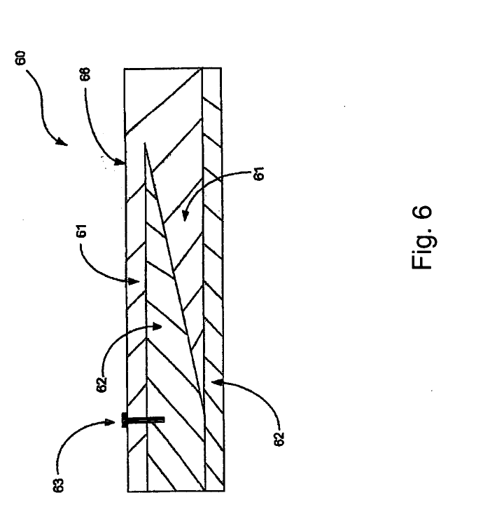

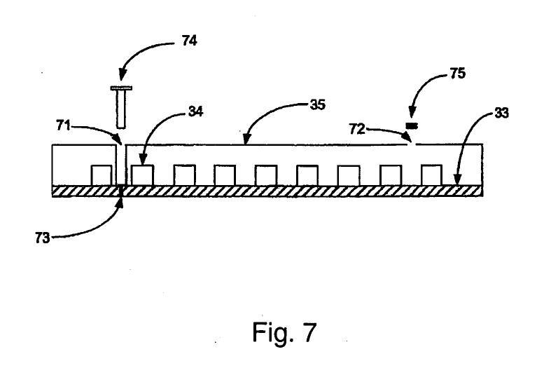

FIG. 3 is a perspective view of the DRA antenna system 30 of the present invention in accordance with an embodiment. In accordance with this embodiment, the DRA antenna system 30 includes a ground plain 31, a microwave feed layer 33, a dielectric substrate 32 interposed between the ground plain 31 and the microwave feed layer 33, dielectric resonator radiating elements 34 arranged in an array, and a radome 35 in contact with, or in proximity to, the radiating elements 34. The radome 35 may be secured in position by attachment devices, embodiments of which are described below in detail with reference to FIGS. 6 and 7.

The compact nature of the DRA antenna system 30 shown in FIG. 3 is illustrated by the dimensions shown in FIG. 3. Although the invention is not limited to any particular dimensions, the dimensions shown in FIG. 3 are in a preferred range. In accordance with this embodiment, the dimensions are 80 centimeters (cm) in the length-wise direction and 30 cm in the width-wise direction. The distance between the upper surfaces of the elements 34 and the bottom side 36 of the top surface 37 of the radome 35 preferably is approximately ¼λ, where λ is the transmission wavelength. Because the bottom side 36 of the top surface 37 of the radome 35 is so close to, or in contact with, the radiating elements 34, the effect-of the radome 35 on the radiation pattern generated by the antenna system typically will be taken into account in the algorithm that controls generation of the radiation patterns and beam steering.

In an embodiment of the present invention, the dielectric elements 34 may have a relatively high permittivity (i.e., higher than that of free space and preferably substantially higher), low conductivity and a low loss tangent. The high permittivity of the dielectric elements 34 enables the size of the elements to be kept small. In an embodiment, each the dielectric element 34 is made of a plastic base filled with a ceramic powder. The plastic material typically will be delivered in the form of a cured slab, although the material may also come in the form of a liquid or gel, which also may be used directly. The dielectric elements 34 may be attached to the upper surface of the microwave feed layer 33 by various materials, including, by way of non-limiting example only, a cyanoacrylate adhesive, a plastic resin with embedded ceramic particles, or mechanical fasteners.

The dielectric elements 34 may be arranged in a variety of configurations, including, for example, a triangular grid, a rectangular grid, and non-uniform grids. Although the elements 34 are shown arranged in a rectangular array of parallel rows of the elements 34, the transmission line structures in the feed layer 33 may be varied so that the electrical paths that connect the elements together are arranged in such a way that various array patterns can be achieved. For example, by way of non-limiting example only, where the centers of adjacent elements form vertices of triangles the element grid is said to be triangular. A triangular element grid may be relatively efficient in terms of number of elements required to provide a desired scan range without excessive grating lobe amplitudes. In particular, the equilateral triangular grid may be efficient if scanning to large angles in all directions is required.

In addition, although the individual elements 34 are shown in FIG. 3 as being rectangular parallelepiped in shape, other shapes are readily usable, such as, for example, hemispherical or pyramidal shapes. The only limitation on shape is that the dielectric resonator element be at, or near, resonance, when tuned by the path or transmission line structure of the feed layer 33, in one or more resonant modes, at the frequency, or frequency band, of operation.

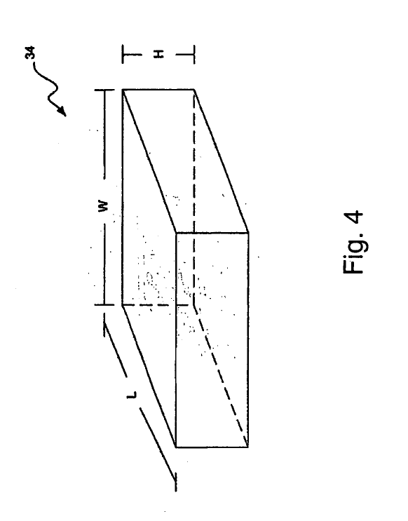

If the DRA antenna system 30 is to radiate circular polarization or have two orthogonal polarizations in the same operating band, then the resonator could have 90° rotational symmetry in order that the impedance matching and pattern characteristics for the two orthogonal polarization components will be similar. For example, with reference to FIG. 4, the length (L) and width (W) of the element 34 may be equal. Each of the dimensions L, W, and H typically are considerably less than one-half of a free-space wavelength. Often, one or more of the dimensions L and W will be just under one-half of the wavelength in the dielectric material comprising the elements 34.

The microwave feed layer 33 may incorporate phase control devices that may allow the phase lengths between the individual elements 34 and the antenna system input and/or output ports to be independently varied. Alternatively, the path lengths are varied in a manner dependent on introductions of phase distributions consistent with the desired radiation pattern. Multiple feed structures may couple into the dielectric elements 34 in order to produce multiple beams. Active gain devices, such as amplifiers, may be inserted between the dielectric elements 34 and the feed or feeds in order to maximize efficiency. Such active gain devices may be on either side of the phase control devices. Devices to control the relative signal strength (amplitude control devices) to and/or from the individual elements 34 may also be included.

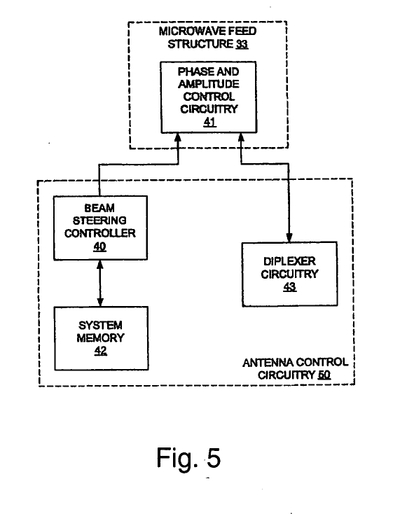

The phase control devices and/or amplitude control devices of the microwave feed structure may be connected to the beam steering controller 40, as shown in FIG. 5. FIG. 5 is a functional block diagram illustrating the electrical control circuitry 50 of the present invention in accordance with an embodiment. The beam steering controller 40 may provide signals to the aforementioned phase and amplitude control devices 41 of the transmission line structures of the feed layer 33 in order to produce the desired array radiation pattern or patterns. In particular, the controller 40 may provide signals that produce the pattern with the optimal trade-off between gain in the direction of an intended satellite that will be used for communications and interference in the direction of satellites and/or receivers that are not being used.

The controller 40 of the present invention is capable of producing a wide variety of beam shapes for any pointing angle (i.e., the direction of the desired satellite and thus also the nominal beam peak) relative to the object on which the antenna 30 is mounted (e.g., an airframe). For example, if interference with other satellites along the geostationary arc is of concern, then the beam shape can be synthesized or optimized for minimum gain along this arc except in the direction of the desired satellite. The control signals preferably are computed by real-time pattern synthesis using parameters such as, for example, aircraft latitude, longitude, orientation, location of the satellite of interest and/or locations of satellites for which interference is to be minimized. This real-time pattern synthesis or optimization may provide greater flexibility and degrees of freedom over the use of techniques that rely on reading prestored values from a lookup table.

By way of non-limiting example only, where the antenna system is used in an aeronautics environment, the positions of the interfering satellites relative to the airframe are a function of the aircraft location and orientation for any given pointing direction relative to the airframe. Real-time pattern synthesis or optimization may enable such factors to be taken into account in beam shaping and steering. System memory 42 in FIG. 5 stores at least one algorithm that may be executed by the controller 40 to perform real-time pattern synthesis or optimization. System memory 42 may also store data used by the controller 40 when executing these algorithms.

The beam steering controller 40 may incorporate one or more external navigation/attitude sensors as a supplement to, or as an alternative to, other means by which the antenna beam may be steered towards the desired satellite. For example, the beam steering controller 40 may use inputs from one or more accelerometers, inclinometers, Inertial Navigation System (INS), Inertial Reference System (IRS), Global Positioning System (GPS), compass, rate sensors or other devices for measuring position, acceleration, motion, or attitude, for example. These may be devices that are used for other purposes on the aircraft or that are installed specifically for the purpose of assisting in the steering of the antenna beam.

The diplexer circuitry 43 provides isolation between the transmission (TX) and reception (RX) frequency bands. This may be achieved by way of, for example, filtering, microwave-isolators, nulling or some combination of these or other mechanisms. The diplexer circuitry 43 may have an integral low noise amplifier in the reception path such that the losses between the isolation device and the low noise amplifier may be minimized, which, consequently, may maximize the system G/T. As stated above, the antenna system of the invention may also be operated in a half-duplex mode, may utilize a circulator, signal processing and/or some other mechanism to separate transmit and receive signals, thus making the diplexer circuitry 43 unnecessary in these alternative configurations.

The radome 35 shown in FIG. 3 may protect the array of dielectric resonator elements 34 from the environment and preferably is relatively transparent to electromagnetic radiation. For example, the radome 35 may be fabricated from a composite of reinforcing fibre and resin, or manufactured from a plastic material. The radome 35 may also influence the radiation from the array of dielectric resonator elements 34 and matching of the dielectric resonator elements 34 due to its close proximity to these elements 34. Thus, the effect of the radome 35 on beam shaping and steering preferably is taken into account by the pattern synthesis or optimization algorithms executed by the beam steering controller 40. The radome 35 may be designed such that the composite performance of the elements 34 and radome 35 together is optimized. This design process is accomplished through optimization of the dimensions of both the elements 34 and the radome 35, and is facilitated by the use of full-wave electromagnetic analysis tools.

FIGS. 6 and 7 illustrate side views of two embodiments of the compact mounting device of the present invention. The compact mounting devices of both embodiments may attach the antenna system 30 shown in FIG. 1 to the mounting surface without increasing the size of the antenna system 30 appreciably beyond that of the radiating structure of the array of dielectric resonator elements 34 itself.

FIG. 6 illustrates an embodiment of the sliding jam-clamp mounting device 60. This structure may include an upper component 61 and a lower component 62. Component 61 may incorporate a wedge that jams into a mating area within component 62. In FIG. 6, the two components are shaded in different directions to enable them to be distinguished from each other. Although the wedge need not be triangular in cross-section, the triangular shape does work well for the intended purpose. Any number of these jam-clamps can be used in mounting the antenna system to the mounting surface, which will be referred to hereinafter as an airframe since the invention is particularly well suited for aeronautical applications. In addition, one or more pieces of anti-sliding hardware 63 may be used to secure the antenna to the jam clamp, such as one or more screws, rivets or bolts, for example, to stop the sections of the jam-clamps from separating. The lower component 62 may be attached to the airframe by similar attachment devices. The ground plane 31 of the antenna system 30 may be secured to the upper surface 66 of upper clamp component 61.

FIG. 7 illustrates the DRA antenna system 30 of the invention attached to an airframe using mounting hardware that passes through the radome 35 into the airframe and attaches firmly to the top of the radome 35. Preferably, either indentations 71 openings 72 are formed in the radome 35 through which the mounting hardware 73 passes down into the feed structure 33. This arrangement allows short, metallic fasteners to be used that are secured tightly between the solid feed structure 33 level and the airframe or interface plate to be used as the mounting hardware 73. The hardware may secure into a interface (adapter) plate or into the airframe itself, for example. If the hardware secures into an interface plate, then this plate is separately secured to the airframe.

It should be noted that short metallic fasteners 73 have a much higher electromagnetic resonant frequency than longer fasteners. The resonant frequencies of the short fasteners 73 thus tend to be far above the operating frequency of the antenna system 30. Consequently, the short metal fasteners have very little impact on the radiation performance of the antenna system 30. The lower position of the fasteners 73 (e.g., below the dielectric resonator elements 34) further ensures that the fasteners 73 are not strongly excited with microwave currents that could affect the radiation patterns or impedance characteristics of the array elements 34 or overall antenna system 30.

Typically, the indentations 71 or openings 72 in the radome 35 will be filled for environmental reasons. Precipitation should be kept out of the radome 35 and indentations or openings, and drag they create, should be minimized. For example, this may be achieved by filling the indentations 71 or openings 72 with plugs 74 and 75, respectively. The plugs 74 or 75 may snap, or otherwise fasten, into the indentations or openings 72 or be bonded into place to fill the indentations 71 or openings 72 to thereby minimize drag. Of course, other types of attachment mechanisms are also suitable for this purpose. By way of non-limiting example only, a flexible adhesive such as RTV may be suitable for securing the plugs in place, as this allows later removal of the plugs and thus of the mounting hardware and of the antenna system itself.

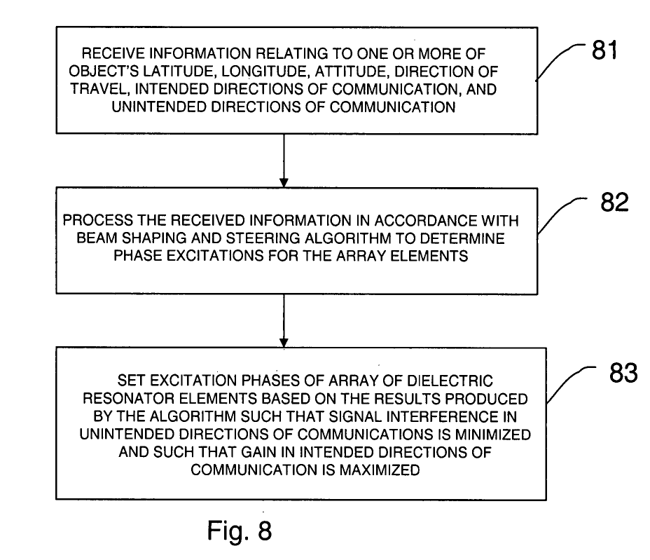

FIG. 8 is a flow chart illustrating a method performed by the beam steering controller 40 shown in FIG. 5. The controller 40 may receive information relating to one or more of the following: object latitude, longitude, attitude, direction of travel, intended directions of communication and/or unintended directions of communication. This step is represented by block 81. The controller 40 may then processes the information in accordance with a beam shaping and steering algorithm executed by the controller 40 to determine the phase excitations for the array elements 34. This step is represented by block 82. The controller 40 may then output signals to the phase and amplitude control circuitry 41 (FIG. 5), which may set the phase excitations of the elements 34 accordingly.

The embodiments disclosed above are not intended to be exhaustive or to limit the invention to the precise forms disclosed in the detailed description. Rather, the embodiments have been chosen and described so that others skilled in the art may utilize their teachings. Although described in the exemplary embodiments, it will be understood that various modifications may be made to the subject matter without departing from the intended and proper scope of the invention.

What is claimed is:

1. A dielectric resonator antenna, comprising:
an array of dielectric resonator elements electrically coupled to feed, each dielectric element having at least one characteristic selected from the group consisting of a relatively high permittivity, a low conductivity and a low loss tangent;
a radome immediately proximate to the array of dielectric resonator elements; and
a controller, wherein said controller controls the antenna feed to control excitation of said dielectric resonator elements.

2. The dielectric resonator antenna of claim 1, wherein the permittivity of the array elements is higher than that of free space, the elements having low conductivity and low loss tangent.

3. The dielectric resonator antenna of claim 1, wherein the array elements are substantially rectangular parallelepiped in shape.

4. The dielectric resonator antenna of claim 1, wherein the array elements are arranged on a nominally planar surface.

5. The dielectric resonator antenna of claim 1, wherein the array elements are arranged in a nominally triangular grid.

6. The dielectric resonator antenna of claim 1, wherein the immediate proximate distance is approximately ¼ of a transmission λ.

7. The dielectric resonator antenna of claim 1, wherein the controller sets the excitation of the elements such that interference in specific directions not of interest are minimized.

8. The dielectric resonator antenna of claim 1, wherein the controller receives information relating to a mounting location of the antenna and uses the information to set excitation phases of the array elements, the information including one or more of object latitude, longitude, attitude, direction of travel, intended direction of communication and unintended directions of communication.

9. The dielectric resonator antenna system of claim 8, wherein the intended direction of communication is in a direction of a satellite with which communication is desired.

10. The dielectric resonator antenna system of claim 8 wherein the unintended directions are in directions of satellites with which communication is undesired.

11. The dielectric resonator antenna of claim 8, wherein the antenna is mounted on a mobile platform.

12. The dielectric resonator antenna of claim 8, wherein the antenna is mounted on a mobile platform selected from the group consisting of an aircraft, a ship, a train, an automobile and a recreational vehicle (RV).

13. The dielectric resonator antenna of claim 11, wherein the controller receives navigational input from navigational aids on the aircraft and uses the received navigational Input to set the excitation of the array elements.

14. The dielectric resonator antenna of claim 1, wherein the controller receives information from at least one of an accelerometer, an Inertial Navigation System (INS), an Inertial Reference System (IRS), a global positioning system (GPS) receiver, and an inclinometer.

15. The dielectric resonator antenna of claim 1, further comprising a mounting apparatus including a sliding jam-clamp being attached to the antenna and attached to a mounted object, wherein portions of the mounting apparatus attached to the antenna and to the mounted object are respectively configured to slidably engage each other in a friction-fit mating, and wherein the mounting apparatus does not appreciably increase the size of the antenna.

16. The dielectric resonator antenna of claim 1, further comprising:
mounting hardware that passes through an opening or indentation in the radome and attaches to the array, and wherein the hardware, when attached, does not extend significantly beyond base portions of the array elements and consequently does not interfere with radiation characteristics of the antenna.

17. The dielectric resonator antenna of claim 1, wherein the controller executes a beam steering that takes into account information including one or more of object latitude, longitude, attitude, direction of travel, intended direction of communication and unintended directions of communication.

18. The dielectric resonator antenna of claim 17, wherein the controller sets the excitation in real-time as information is processed in accordance with the beam steering being executed by the controller.

19. The dielectric resonator antenna of claim 1, wherein the array elements each comprise a plastic base filled with a ceramic powder.

20. The dielectric resonator antenna of claim 1, wherein the array elements are attached to a substrate of the antenna feed by a Cyanoacrylate adhesive.

21. The dielectric resonator antenna of claim 18, wherein the beam steering controls a beam shape to provide an optimized trade-off between gain in an intended direction of communication and interference in an unintended communication direction.

22. A method of communicating with a dielectric resonator array antenna, the method comprising:
receiving antenna beam shaping and steering information, the information including one or more of object latitude, longitude, attitude, direction of travel, intended direction of communication and unintended directions of communication; and
processing the information in real-time in the controller to determine an optimized excitation for an array of high permittivity dielectric elements that comprise the antenna; and
exciting the array elements in real-time based on the determination by the controller.

23. The method of claim 22, wherein the permittivity of the array elements is higher than that of free space, the elements having low conductivity and low loss tangent.

24. The method of claim 22, wherein the array elements are substantially rectangular parallelepiped in shape.

25. The method of claim 22, wherein the array elements are arranged on a nominally planar surface.

26. The method of claim 22, wherein the array elements are arranged in a nominally triangular grid.

27. The method of claim 22, wherein the excitation of the elements are set such that interference in specific directions is minimized.

28. The method of claim 22, wherein the intended direction of communication is in a direction of a satellite with which communication is desired.
